(19) United States
(12) Patent Application Publication
(10) Pub. No.: US 2023/0061842 A1
(43) Pub. Date: Mar. 2, 2023

(54) USER-CONTROLLED VEHICLE TELEMATICS

(71) Applicant: ALLSTATE INSURANCE COMPANY, Northbrook, IL (US)

(72) Inventors: Timothy W. GIBSON, Barrington, IL (US); Marvin LU, Chicago, IL (US); Thomas J. WILSON, Chicago, IL (US); Aleksandr LIKHTERMAN, Wheeling, IL (US); Raja THIRUVATHURU, Aurora, IL (US); Deepak P. RAJ, Carol Stream, IL (US)

(21) Appl. No.: 17/863,131

(22) Filed: Jul. 12, 2022

Related U.S. Application Data
(63) Continuation-in-part of application No. 17/587,815, filed on Jan. 28, 2022.
Application No. 17/587,815 is a continuation-in-part of application No. 17/587,799, filed on Jan. 28, 2022.
(60) Provisional application No. 63/239,215, filed on Aug. 31, 2021.
(60) Provisional application No. 63/239,215, filed on Aug. 31, 2021.

(51) Int. Cl. G06Q 30/02; G07C 5/00; G07C 5/08; B60W 40/09

(52) U.S. Cl. CPC G06Q 30/0218; G06Q 30/0211; G07C 5/008; G07C 5/0841; B60W 40/09; B60W 2540/30

(57) ABSTRACT

Implementations described herein provide systems and methods for vehicle telematics control. In one implementation, telematics data for a particular user is obtained. The telematics data is captured using at least one sensor associated with a vehicle in connection with an operation of the vehicle by the particular user. A privacy vault of the particular user is identified. The privacy vault has a user-defined access permission set for at least one service provider. The telematics data is stored in the privacy vault. Access to the telematics data stored in the privacy vault by the at least one service provider is controlled. The access to the telematics data controlled according to the user-defined access permission set for the at least one service provider.

### CROSS-REFERENCE TO RELATED APPLICATIONS

The present application is a continuation-in-part of and claims priority to U.S. patent application Ser. No. 17/587,815, filed on Jan. 28, 2022, which claims priority to U.S. Provisional Patent Application No. 63/239,215, filed on Aug. 31, 2021. The present application is a continuation-in-part of and claims priority to U.S. patent application Ser. No. 17/587,799, filed on Jan. 28, 2022, which also claims priority to U.S. Provisional Patent Application No. 63/239,215, filed on Aug. 31, 2021. Each of these applications is incorporated by reference in its entirety herein.

### FIELD

Aspects of the present disclosure relate to systems and methods for personal data control for a particular user and more particularly to an end-to-end privacy ecosystem for user control of selective sharing personal data, such as vehicle telematics data.

### BACKGROUND

Users generate vast quantities of personal data on a regular basis. For example, users consistently generate personal data through user interaction with various services provided by service providers. As technological capabilities increase and the personal data inherently becomes more intimate, users are becoming more sensitive to privacy concerns involving personal data generation and access. However, users typically have little insight into what personal data is being generated, let alone which parties may have access to the personal data and ultimately for what the personal data is used. Additionally, with the quantity of personal data being generated on a regular basis, it is impractical for the onus to be on users to manage and secure personal data, as well as provide access to personal data in response to significant numbers of individual requests from service providers.

On the other hand, service providers use personal data to optimize services provided to users. While some service providers are positioned to directly capture personal data from users, many services providers have to purchase personal data from third party sources, often for a substantial cost. Additionally, the personal data obtained by service providers, whether directly or indirectly via third party sources, typically includes vast amounts of personal data that is irrelevant to the particular needs of the service provider, requiring the service provider to analyze and filter the personal data to identify relevant personal data and thereby further increasing the cost born by the service provider. Exacerbating these challenges, the personal data may be generated in a myriad of formats, such that further costs are expended by the service provider in converting data formatting of the personal data into a data format needed by the service provider.

It is with these observations in mind, among others, that aspects of the present disclosure were conceived and developed.

### SUMMARY

Implementations described and claimed herein address the foregoing by providing systems and methods for personal data control, such as vehicle telematics control. In one implementation, telematics data for a particular user is obtained. The telematics data is captured using at least one sensor associated with a vehicle in connection with an operation of the vehicle by the particular user. A privacy vault of the particular user is identified. The privacy vault has a user-defined access permission set for at least one service provider. The telematics data is stored in the privacy vault. Access to the telematics data stored in the privacy vault by the at least one service provider is controlled. The access to the telematics data controlled according to the user-defined access permission set for the at least one service provider.

In another implementation, telematics data for a particular user in connection with a telematics-based service offered by at a service provider is requested. The telematics data is captured using at least one sensor associated with a vehicle in connection with an operation of the vehicle by the particular user. The telematics data is stored in a privacy vault of the particular user, and the privacy vault has a user-defined access permission set for the service provider. Access to the telematics data stored in the privacy vault by a service provider server is obtained. The access to the telematics data is controlled according to the user-defined access permission set for the service provider.

In another implementation, at least one sensor is associated with a vehicle. The at least one sensor captures telematics data for the particular user in connection with an operation of the vehicle by the particular user. At least one computing device sends the telematics data to a privacy control system. The privacy control system stores the telematics data in a privacy vault of the particular user. The privacy vault has a user-defined access permission set for a service provider.

In another implementation, a request is received from a user device to sign into a telematics application for a telematics-based service. The telematics application is executed by a service provider server associated with a service provider. One or more provider conditions for the telematics application is determined. One or more user preferences of the particular user for controlling access to one or more data types corresponding to the telematics application is identified. A comparison of the one or more provider conditions for the telematics application with the one or more user access preferences is generated. A privacy vault for the particular user for storing data associated with the telematics application is identified. A user-defined access permission for the service provider is generated based on the comparison. The user-defined access permission corresponds to the privacy vault.

In another implementation, a user is prompted to selectively sign into a telematics application for a telematics-based service. The telematics application is executed by a service provider server associated with a service provider. A provider policy for the telematics application is provided. An indication of a user-defined access permission for the service provider is received. The user-defined access permission corresponds to a privacy vault for the particular user. The user-defined access permission is defined based on a comparison of one or more provider conditions for the provider policy with one or more user access preferences for the privacy vault.

In another implementation, at least one computing device sends a request to sign into a telematics application for a telematics-based service. The telematics application is executed by a service provider server associated with a service provider. A display of the at least one computing device presents an indication of a user-defined access permission for the service provider. The user-defined access permission corresponds to a privacy vault for the particular user. The user-defined access permission is defined based on a comparison of one or more provider conditions for the telematics application with one or more user access preferences for the privacy vault.

In another implementation, a request from a telematics application for accessing telematics data for a particular user is received. The telematics application executed by a service provider server associated with a service provider offering a behavior-based service. A privacy vault for the particular user is identified. The privacy vault stores the telematics data corresponding to the request from the telematics application. The request for accessing the telematics data is compared to a user-defined access permission for the service provider. The user-defined access permission corresponds to the privacy vault. Access to the telematics data in the privacy vault is controlled in response to the request. The access is controlled according to the user-defined access permission.

In another implementation, a request for accessing telematics data for a particular user is generated. The request is associated with a service provider offering a telematics-based service. The request is sent to a privacy control system. The telematics data is accessed using the privacy control system based on a user-defined access permission controlling access to a privacy vault associated with the particular user. The privacy vault stores the telematics data.

In another implementation, at least one computing device receives a notification from a privacy control system. The notification specifies a request by a telematics application to access telematics data associated with a particular user. The telematics application is executed by a service provider server associated with a service provider. A display of the at least one computing device presents an indication of a user-defined access permission for the service provider. The user-defined access permission corresponds to a privacy vault for the particular user. The privacy vault stores the telematics data, and access to the telematics data by the telematics application is controlled based on the user-defined access permission.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example environment for controlling access to telematics data for a particular user.

FIG. 2 is an example end-to-end privacy ecosystem for controlling access to telematics data for a particular user.

FIG. 3 illustrates example operations for vehicle telematics control, including establishing user control of telematics data access.

FIG. 4 illustrates example operations for vehicle telematics control, including telematics data storage for user-controlled access.

FIG. 5 illustrates example operations for vehicle telematics control, including providing user- controlled access to telematics data.

FIG. 6 shows an example network environment that may implement various systems and methods discussed herein.

FIG. 7 is an example computing system that may implement various systems and methods discussed herein.

### DETAILED DESCRIPTION

Aspects of the presently disclosed technology generally relate to systems and methods for personal data control by individual users over what personal data is generated and stored, what parties the personal data is accessed by, and how the personal data is used by those parties. As such, each particular user is provided with privacy and ownership of the personal data for the particular user, such that the particular user can control and, in some cases monetize, access to the personal data. Access to the personal data by parties, such as service providers, is transparent (e.g., through standardization and education), with the particular user retaining the ability to modify access in exchange for services by one or more service providers or otherwise in agreement with the service providers. The personal data accessed by a service provider may be identified as responsive to a request by the service provider. Moreover, the personal data may be stored in a platform independent format, thereby eliminating any need for converting a data format of the personal data for use by a service provider system of the service provider. As such, the particular user enjoys privacy, insight into, and control over the personal data, while the service provider obtains access to the personal data at a reduced cost.

The various systems and methods disclosed herein generally provide for user-controlled personal data access. The examples provided herein reference telematics data, telematics applications, telematics-based services, and other telematics and vehicle related features. It will be appreciated, however, that the presently disclosed technology is applicable to other personal data, applications, services, and the like.

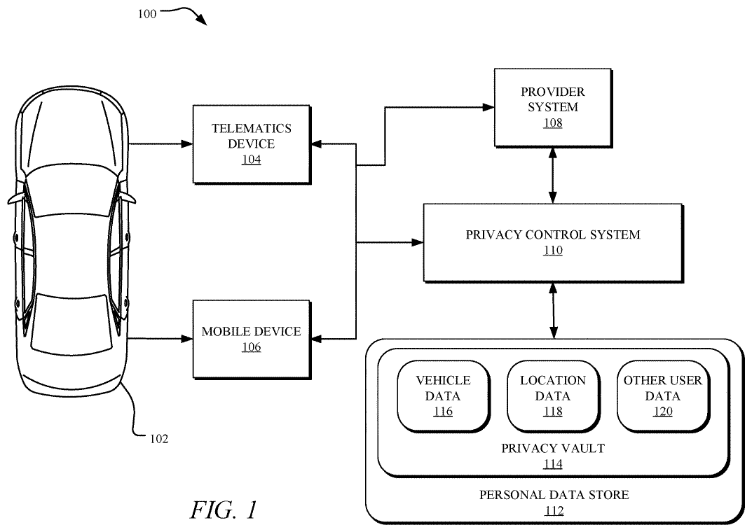

To begin a detailed description of an example environment 100 for controlling access to telematics data for a particular user, reference is made to FIG. 1. In one implementation, the example environment 100 includes a vehicle 102 associated with the particular user. The vehicle 102 may be owned and/or operated by the particular user. Operation of the vehicle 102 may include the particular user driving the vehicle 102. Telematics data may be generated in connection with the operation of the vehicle 102.

The telematics data may be generated or otherwise captured by a telematics device 104, a mobile device 106, and/or other devices, such as an onboard vehicle controller of the vehicle 102. One or more sensors configured to measure or otherwise capture the telematics data may be integrated into and/or in communication with the telematics device 104, the mobile device 106, and/or the other devices. A provider system 108 associated with a service provider may desire the telematics data for the particular user for various purposes, including for the provision of one or more services to the particular user, such as telematics-based services. As detailed herein, a privacy control system 110 may be used by the particular user to capture, store, and share the telematics data with the provider system 108. The privacy control system 110 may store the telematics data in one or more privacy vaults 114 of the particular user. The one or more privacy vaults may be in a personal data store 112 associated with the particular user. It will be appreciated that the personal data store 112 may be a single privacy vault or include multiple privacy vaults. Further, the privacy vaults 114 and the personal data store 112 may be integrated or distinct from each other or otherwise combined or associated with each other in various manners. The privacy control system 110 controls access to the telematics data by the provider system 108 in accordance with the permission and control of the particular user. The personal data store 112 may be specific to the particular user with the privacy control system 110 managing and controlling access to a plurality of personal data stores for various users, with each of the personal data stores corresponding to a specific user having specific user preferences for data access.

The telematics data may include location data 118, such as global position system (GPS) coordinates during the operation of the vehicle 102. The location data 118 may be used to track a location of the vehicle 102 during particular periods of time, which may be used to determine travel paths associated with the operation of the vehicle 102 by the particular user. The travel paths may be used to determine driving characteristics of the particular user including where the particular user drives, how much the particular user drives, when the particular user drives (e.g., how much during the day, how much during the night, how much during adverse driving conditions, etc.).

The location data 118 may further include acceleration data for the vehicle 102 during the operation of the vehicle 102. The acceleration data may be used to determine a speed of travel along the travel paths and identify any rapid deceleration or acceleration. The speed of travel may be used to determine whether the particular user is prone to speeding, while the rapid deceleration may be used to identify hard breaking by the particular user and the rapid acceleration may be used to identify other behavior characteristics, such as racing or recklessness. As such, the acceleration data may be used to determine driving characteristics of the particular user involving how the particular user drives.

Vehicle data 116 corresponding to operational parameters of the vehicle 102 may further be captured. The vehicle data 116 may be captured using systems, controllers, and/or sensors of the vehicle 102. The vehicle data 116 may be communicated to the privacy control system 110 either directly from the vehicle 102 or via the telematics device 105, the mobile device 106, and/or other devices. The vehicle data 116 may be used to determine behavior characteristics, such as driving characteristics, vehicle maintenance characteristics, and/or the like based on how the vehicle 102 is operating and maintained. Other user data 120, including, without limitation, browser searching history, historical data, purchase history, advertisement interaction, social media, user identifying data, policy data, and/or the like, may be captured and stored in the privacy vault(s) 114.

The other user data 120 may be used to determine other driving characteristics or behavior characteristics for the particular user. The driving characteristics and/or the behavior characteristics generated using the data 116-120 may be used by the provider system 108 to generate a driving behavior profile, including a risk tolerance and/or a risk of loss. The driving behavior profile of the particular user may be used to determine if the particular user meets behavior thresholds (e.g., safe driving thresholds) to qualify for particular service offerings (e.g., a safe driving discount) by a service provider, such as an automobile insurance provider. In this manner, the service provider may provide a behavior-based service. The behavior-based service may include, without limitation, a behavior-based pricing service, such as generating an automobile insurance quote based on the driving behavior for the particular user where the driving behavior is determined based on the telematics data for the particular user. It will be appreciated that the behavior-based service may be other services that are based on behavior characteristics of one or more users.

The privacy control system 110 may store the data 116-120 in the privacy vault(s) 114 within the personal data store 112 for the particular user according to a direction of the particular user. For example, the data 116-120 may be stored in: a single privacy vault corresponding to telematics data; separate privacy vaults according to the vehicle data 116, the location data 118, and the other user data 120; and/or combinations thereof. The particular user may have a plurality of different privacy vaults in the personal data store 112 for the particular user. Access to data in each of the privacy vaults 114 by the provider system 108 and/or other devices or parties is controlled by the privacy control system 110 based on a user-defined access permission corresponding to the privacy vault 114. The user-defined access permission may be set for the service provider associated with the provider system 108 requesting the telematics data from the privacy vault 114. Based on the user-defined access permission, access to the telematics data by the provider system 108 may be granted or denied. Where the access is granted, the access may be controlled in various manners as described herein.

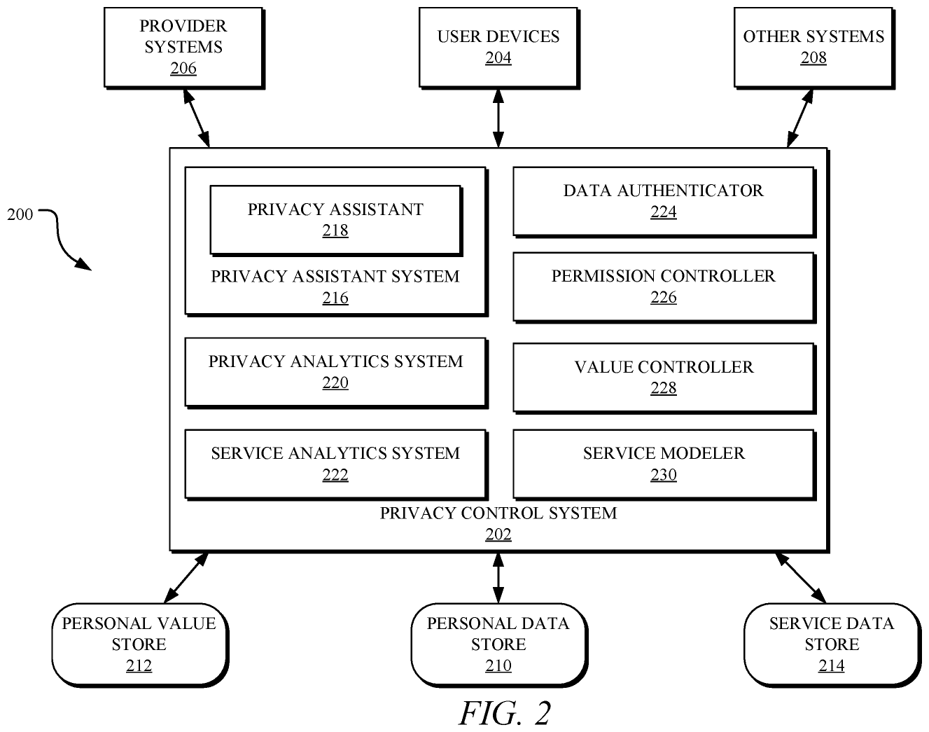

Turning to FIG. 2, an example end-to-end privacy ecosystem 200 for controlling access to telematics data for a particular user is shown. In one implementation, the end-to-end privacy ecosystem 200 includes a privacy control system 202 in communication with one or more user devices 204, one or more provider systems 206, and/or other systems 208. The user devices 204 may be associated with one or more particular users. For example, the user devices 204 may include the mobile device 106 associated with the particular user. Each of the particular users may provide, modify, and control personal data, such as the telematics data, via the privacy control system 202. For each particular user, the personal data may be captured with the user device 204 and/or the other systems 208, which may include various data sources, such as the telematics device 104, the mobile device 106, the vehicle 102, and/or the like.

The particular user may interact with the provider control system 202 using the user device 204 to access a personal data store 210, a personal value store 212, a service data store 214, and/or other aspects of the privacy control system 202. The personal data store 210 may store the personal data in one or more privacy vaults according to one or more user-defined access permissions set for each privacy vault in the personal data store 210 for the particular user. Each of the user-defined access permissions may be set for a service provider desiring access to data stored in the privacy vault. The personal data in the privacy vaults in the personal data store 210 for the particular user may be categorized, labeled, and/or stored in various manners. For example, each privacy vault may correspond to an access level, a data type, a service provider, a time period, a particular request, and/or the like. As such, the privacy control system 202 may easily identify and provide access to specific personal data responsive to particular actions, such as a request by the provider systems 206 for access to the specific personal data, such as the telematics data. Such access is controlled using the user-defined access permissions associated with the privacy vault(s) in which the specific personal data is stored. The personal data accessed by the service provider system 206 may be identified as responsive to a request by the service provider. Moreover, the personal data may be stored in the personal data store 210 in a platform independent format, thereby eliminating any need for converting a data format of the personal data for use by the service provider system 206. In this manner, the particular user enjoys privacy, insight into, and control over the personal data, while the service provider obtains access to the personal data at a reduced cost, among other benefits.

As detailed herein, the user-defined access permissions may be set for a particular service provider. The service data store 214 may store or otherwise obtain data from the provider system 206 associated with the service provider. The data may include, for example, a provider policy defining terms and conditions for use of the personal data in exchange for one or more services for the particular user provided by the service provider. However, the particular user may not understand the terms and conditions of the provider policy, particularly with sufficient transparency to understand how the personal data will be used, when it will be used, who it will be used by, and whether the particular user retains any control over the use of the personal data after providing access. As such, the privacy control system 202 may include a privacy assistant system 216 facilitating user education and control. The privacy assistant system 216 may generate a user interface for interaction with the stores 210-214 and aspects of the privacy control system 202 by the user device 204, as well as the provider systems 206 and the other systems 208 that may want to access particular personal data for the particular user. For example, the privacy assistant system 216 may provide access to a privacy assistant 218, which may be an avatar, a user interface, and/or the like to facilitate education and control for the particular user with respect to various aspects of the personal data for the particular user. In some examples, the privacy assistant 218 may be a live person matched to the particular user to facilitate education and control of the personal data of the particular user. In other examples, the privacy assistant 218 is automatically generated by the privacy assistant system 216. The privacy assistant system 216 leverages various systems and components, such as a privacy analytics system 220, a service analytics system 222, a data authenticator 224, a permission controller 226, a value controller 228, a service modeler 230, and/or the like, to provide user education and control of personal data.

For example, the particular user may lack an understanding of what personal data has been generated and what that personal data may indicate about the particular user. Accordingly, the privacy assistant system 216 may leverage the privacy analytics system 220 to generate a summary of the personal data stored in the personal data store 210, including a summary of the privacy vaults, personal data stored in the privacy vaults, a source of the personal data stored in the privacy vaults, current and historical access to the personal data by the provider systems 206 and/or the other systems 208, and any behavioral patterns or user insights about the particular user that may be identified based on the personal data stored in one or more of the privacy vaults in the personal data store 210. The summary of the personal data generated by the privacy analytics system 220 may be provided to the user device 204 for the particular user in a user-friendly manner using the privacy analytics system 216. Queries for additional analytics may be submitted by the user device 204 using the privacy assistant system 216, and the privacy analytics system 220 may generated appropriate responses.

Additionally, as described above, understanding an impact of a provider policy governing data access and permissions by a service provider may be daunting for most users. As such, the privacy assistant system 216 may leverage the service analytics system 222 to determine one or more provider conditions for the service provided by the service provider, such as a telematics application generated by the provider system 206 for providing a telematics-based service. The service analytics system 222 may access the service data store 214 to access the provider policy associated with the provider system 206. In one implementation, the service analytics system 222 parses the provider policy and extracts one or more policy requirements from the provider policy based on pre-defined criteria. As one example, the pre-defined criteria may correspond to type of access, type of use, duration of use, and user-retained control parameters. The service analytics system 222 may generate the one or more provider conditions based on the one or more policy requirements. As such, the service analytics system 222 may provide a customized approach to characterizing the provider policy for a particular service provider in an easily digestible format for the particular user. The characterization of the provider policy may be provided as a high-level summary of the provider conditions to the particular user using the privacy assistant system 216. The high-level summary may include explanations of the provider conditions.

Alternatively or additionally, the service analytics system 222 may identify a standardized tier corresponding to a provider policy for the provider policy. The standardized tier may define the one or more provider conditions. The standardized tier may be, for example, a guest tier, a private tier, an anonymous tier, an open tier, and/or the like. The guest tier may limit the personal data to be access as needed for a present interaction with the service provider (e.g., in providing the telematics-based service). The private tier may permit the service provider to retain the personal data but only use it on behalf of the particular user. The anonymous tier may permit sharing and usage of the personal data, as well as merging the personal data with other data, as long as the personal data is anonymized prior to any action or use by the service provider. The open tier may permit the service provider to use the personal data without restriction.

The service analytics system 222 may determine if the provider conditions include any condition regarding a certification that the personal data belongs to or otherwise corresponds to the particular user. For example, in generating an automobile insurance quote, the service provider needs a reasonable certainty regarding whether the telematics data corresponds to the operations of the vehicle 102 by the particular user, as opposed to another user. With such a reasonable certainty, the generation of driving behavior characteristics, driving behavior profiles, and ultimately an insurance quote for the driver based on risk tolerance and risk of loss may be flawed. Accordingly, the data authenticator 224 may be used to generate an authentication certificate certifying that the personal data corresponds to the particular user and/or provide other personal data for confirming that the personal data corresponds to the particular user. The authentication certificate may be generated in connection with capturing the personal data using one or more personal identifiers of the particular user (e.g., biometrics, pins, vehicle identifiers, etc.). As another example, the authentication certificate may be generated by identifying behavioral patterns in the personal data, cross-referencing the personal data with other data for the particular user, and/or the like. The authentication certificate may be provided by the provider control system 202 to the provider system 206 in connection with providing access to the personal data. In addition or alternative to providing the authentication certificate, the underlying data for confirming an authenticity of the personal data may be provided along with access to the personal data to the provider system 206.

The permission controller 226 may be used by the particular user to define and/or modify user preferences for accessing the personal data in the privacy vaults of the personal data store 210, as well as for writing and/or storing personal data in the personal data store 210. For example, the particular user may specify whether to store personal data in the personal data store 210 and/or provide the personal data directly to a requesting party. As described herein, the particular user may provide such a specification in response to being prompted to sign into a particular application executed by the provider system 206, such as a telematics application, using the privacy control system 202. In response to signing into the particular application with the privacy control system 202, the privacy assistant system 216 may ask the particular user whether to direct any personal data generated through an interaction with the particular application to the personal data store or to the particular application. The privacy control system 202 may compare the user preferences with the provider conditions to generate the user-defined access permissions for the particular application executed by the provider system 206, as described herein, and provide a summary of the comparison, as well as the user-defined access permission, to the particular user via the privacy assistant system 216.

The user-defined access permission may include a data type, an access type, an access duration, an access value, and/or the like. The access type may include a service-related use in providing a service to the particular user via the provider system 206. For example, the service may be a telematics-based service. The telematics-based service may include, for example, a behavior-based pricing service, such as generating an automobile insurance quote based on driving behavior for the particular user where the driving behavior is determined based on the telematics data for the particular user. As other examples, the telematics-based service may include characterizing a driving behavior of the particular user; determining whether a driving behavior of the particular user meets behavior thresholds to qualify for particular service offerings by the service provider; vehicle diagnostics and maintenance; and/or the like. The access type may otherwise include targeted advertising, third-party sharing, selling, storing, access-only and/or the like, as well as the service-related use. The data type may specify a type of personal data, such as telematics data, location data, browser searching history, historical data, purchase history, advertisement interaction, social media, user identifying data, policy data, and/or the like. The access duration may include a particular period of time, a renewable period of time, unlimited, ongoing subject to termination, one-time access, and/or the like.

The access value may include compensation (e.g., monetary, currency, cryptocurrency, non-fungible tokens, redeemable certificates, etc.) or a discount (e.g., on a price for services offered by the service provider). The value controller 228 may control the provision, exchange, storage, and use of the compensation and discounts. Value data regarding the compensation and discounts may be stored in the personal value store 212, and the value controller 228 may communication with the provider system 206, the user device 204, and the other systems 208 to facilitate services related to the compensation and discounts for the particular user. The access value may be summarized for presentation to the particular user using the privacy assistant system 216, so the particular user understands actual or potential compensation or discounts associated with the access of particular data to a particular service provider, which may be used to authorize, decline, or otherwise control access to particular personal data by particular service providers.

Similarly, the service modeler 230 may be used to provide insight for the particular user into a scope and nature of a potential offer for the service. In some examples, prior to providing access to the personal data, a service offered by the service provider may be modeled by the service modeler 230 using the personal data stored in the privacy vault in the personal data store 210. For example, a behavior-based pricing service may be modeled prior to providing the service provider access to the telematics data, with the behavior-based pricing service modeled based on the telematics data stored in the privacy vault. Further, a first service of a first service provider may be compared to a second service of a second service provider (and so on for any number of service providers). Based on the comparison, the particular user can decide which of the service providers to provide access to the personal data or to continue shopping for other service providers.

As such, the provider control system 202 introduces a new paradigm of user-controlled personal data access. Overall, the provider control system 202 provides personal data control by individual users over what personal data is generated and stored, what parties the personal data is accessed by, and how the personal data is used by those parties and when. As such, each particular user is provided with privacy and ownership of the personal data for the particular user, such that the particular user can control and, in some cases monetize, access to the personal data. Access to the personal data by parties, such as service providers, is transparent (e.g., through standardization and education), with the particular user retaining the ability to modify access in exchange for services by one or more service providers or otherwise in agreement with the service providers.

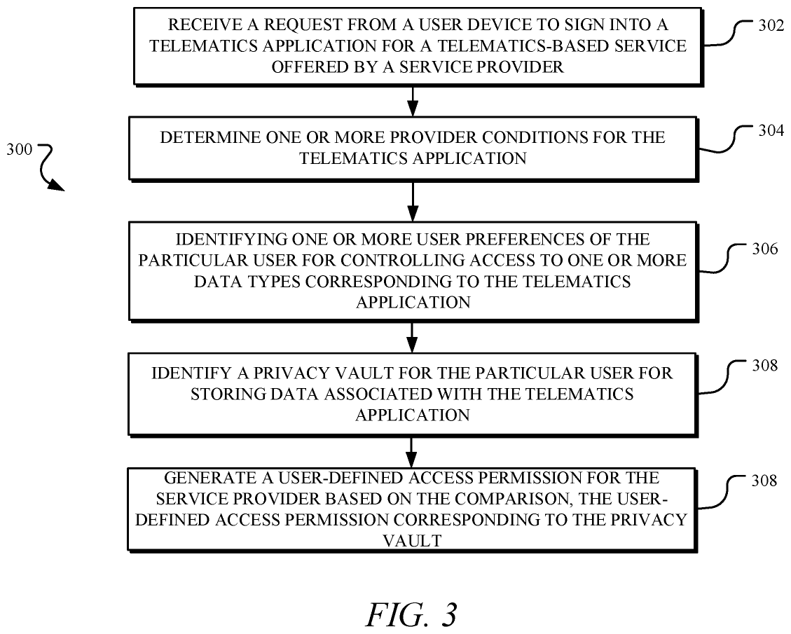

Referring to FIG. 3, example operations 300 for vehicle telematics control, including establishing user control of telematics data access, are shown. It will be appreciated, however, that the operations 300 may be applied in contexts involving other types of personal data, applications, and services. In one implementation, an operation 302 receives a request from a user device to sign into a telematics application for a telematics-based service, where the telematics application is executed by a service provider server associated with a service provider. The telematics application may provide a service, such as a telematics-based service. The telematics-based service may include, for example, a behavior-based pricing service, such as generating an automobile insurance quote based on driving behavior for the particular user where the driving behavior is determined based on the telematics data for the particular user. As other examples, the telematics-based service may include characterizing a driving behavior of the particular user; determining whether a driving behavior of the particular user meets behavior thresholds to qualify for particular service offerings by the service provider; vehicle diagnostics and maintenance; and/or the like.

An operation 304 determines one or more provider conditions for the telematics application. For example, the operation 304 may parse a provider policy for the telematics application and extract one or more policy requirements from the provider policy based on pre-defined criteria. The operation 304 may generate the one or more provider conditions based on the one or more policy requirements. Alternatively or additionally, the operation 304 may identify a standardized tier corresponding to a provider policy for the telematics application. The standardized tier may define the one or more provider conditions. The standardized tier may be, for example, a guest tier, a private tier, an anonymous tier, an open tier, and/or the like. The guest tier may limit the telematics data to be access as needed for a present interaction with the service provider (e.g., in providing the telematics-based service). The private tier may permit the service provider to retain data but only use it on behalf of the particular user. The anonymous tier may permit sharing and usage of the telematics data, as well as merging the telematics data with other data, as long as the telematics data is anonymized prior to any action or use by the service provider. The open tier may permit the service provider to use the telematics data without restriction.

An operation 306 identifies one or more user preferences of the particular user for controlling access to one or more data types corresponding to the telematics application. For example, the operation 306 may define and/or select the privacy vault in response to the request from the user device. The one or more user access permissions for the privacy vault may be defined through one or more prompts to the user presented using the display. An operation 308 generates a comparison of the one or more provider conditions for the telematics application with the one or more user access preferences. The comparison may be provided to the particular user via a display of a user device to provide insight and education regarding what information will be accessed, who will have access, and how the information will be used/what the access will involve. An operation 310 identifies a privacy vault in a personal data store for the particular user for storing data associated with the telematics application. An operation 312 generates a user-defined access permission for the service provider based on the comparison. The user-defined access permission corresponds to the privacy vault.

In one example, the operation 312 may identify any differences between the one or more provider conditions and the one or more user preferences based on the comparison and generate a notification explaining the differences between the one or more provider conditions and the one or more user preferences. The notification may be sent to the user device. The operation 312 may receive a resolution of the differences between the one or more provider conditions and the one or more user preferences. In this example, the user-defined access permission is generated based on the resolution. The resolution may involve the particular user and/or the service provider modifying the provider conditions and/or the user preferences to reach an agreement. This may be a manual process conducted by the particular user and the service provider and/or at least partially automated, including through the use of machine learning algorithms to modify the provider conditions and/or the user preferences based on weighted parameters specified by the particular user and/or the service provider. For example, if a particular user preference is associated with a weighted parameter specifying that the particular user preference is very important to the particular user and a corresponding provider condition is associated with a weighted parameter specifying that the corresponding provider condition is somewhat important to the service provider, the resolution may be automatically generated by adopting the particular user preference in generating the user-defined access permission.

The user-defined access permission may include a data type, an access type, an access duration, an access value, and/or the like. The access type may include a service-related use in providing a telematics-based service to the particular user. The telematics-based service may include, for example, a behavior-based pricing service, such as generating an automobile insurance quote based on driving behavior for the particular user where the driving behavior is determined based on the telematics data for the particular user. As other examples, the telematics-based service may include characterizing a driving behavior of the particular user; determining whether a driving behavior of the particular user meets behavior thresholds to qualify for particular service offerings by the service provider; vehicle diagnostics and maintenance; and/or the like. The access type may otherwise include targeted advertising, third-party sharing, selling, storing, access-only and/or the like, as well as the service-related use. The access value may include compensation (e.g., monetary, currency, cryptocurrency, non-fungible tokens, redeemable certificates, etc.) or a discount (e.g., on a price for services offered by the service provider). The data type may specify a type of personal data, such as telematics data, location data, browser searching history, historical data, purchase history, advertisement interaction, social media, user identifying data, policy data, and/or the like. The access duration may include a particular period of time, a renewable period of time, unlimited, ongoing subject to termination, one-time access, and/or the like.

The data associated with the telematics application may include telematics data. Accordingly, telematics data requested by the telematics application for the particular user may be obtained. The telematics data may be captured using at least one sensor associated with a vehicle in connection with an operation of the vehicle by the particular user. The telematics data may be captured using at least one sensor associated with a vehicle in connection with an operation of the vehicle by the particular user. The telematics data may be real-time data captured during an operation of a vehicle, historical data captured through interaction with location-based services or other services, and/or the like. The at least one sensor may be associated or integrated with a mobile device, a telematics device, a vehicle controller, remote sensors, and/or the like. Access to the telematics data by the telematics application may be controlled according to the user-defined access permission for the service provider. In some examples, the access value associated with the access to the telematics data is provided based on the user-defined access permission for the service provider. This may include, without limitation, providing compensation to a personal value store associated with the particular user; providing a discount in connection with providing the telematics-based service to the particular user; and/or the like.

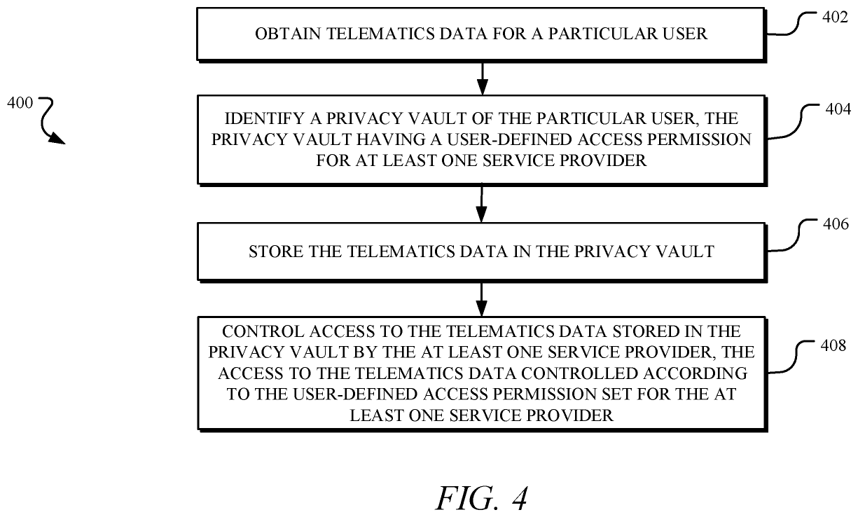

FIG. 4 illustrates example operations 400 for vehicle telematics control, including telematics data storage for user-controlled access. It will be appreciated, however, that the operations 400 may be applied in contexts involving other types of personal data, applications, and services. In one implementation, an operation 402 obtains telematics data for a particular user. The telematics data may be captured using at least one sensor associated with a vehicle in connection with an operation of the vehicle by the particular user. The telematics data may be real-time data captured during the operation of the vehicle, historical data captured through interaction with location-based services or other services, and/or the like. The at least one sensor may be associated or integrated with a mobile device, a telematics device, a vehicle controller, remote sensors, and/or the like.

An operation 404 identifies a privacy vault in a personal data store of the particular user. In one implementation, the privacy vault has a user-defined access permission set for at least one service provider. The user-defined access permission may be set for the at least one service provider based on one or more user preferences for the particular user and one or more provider conditions for the at least one service provider. For example, the one or more provider conditions may be defined by a standardized access tier. As described above, the standardized tier may be, for example, a guest tier, a private tier, an anonymous tier, an open tier, and/or the like. In another example, the one or more provider conditions are generated based on one or more provider policies of the at least one service provider.

As described herein, the user-defined access permission may include a data type, an access type, an access duration, an access value, and/or the like. The access type may include a service-related use in providing a telematics-based service to the particular user. The telematics-based service may include, for example, a behavior-based pricing service, such as generating an automobile insurance quote based on driving behavior for the particular user where the driving behavior is determined based on the telematics data for the particular user. As other examples, the telematics-based service may include characterizing a driving behavior of the particular user; determining whether a driving behavior of the particular user meets behavior thresholds to qualify for particular service offerings by the service provider; vehicle diagnostics and maintenance; and/or the like. The access type may otherwise include targeted advertising, third-party sharing, selling, storing, access-only and/or the like, as well as the service-related use. The access value may include compensation (e.g., monetary, currency, cryptocurrency, non-fungible tokens, redeemable certificates, etc.) or a discount (e.g., on a price for services offered by the service provider). The data type may specify a type of personal data, such as telematics data, location data, browser searching history, historical data, purchase history, advertisement interaction, social media, user identifying data, policy data, and/or the like. The access duration may include a particular period of time, a renewable period of time, unlimited, ongoing subject to termination, one-time access, and/or the like.

An operation 406 stores the telematics data in the privacy vault. The telematics data may be stored using various encryption and/or security techniques. The telematics data may also be stored in a structured manner or using one or more labels for identifying particular telematics data. In connection with storage, the telematics data may be converted and normalized from a platform specific format specified by one or more devices capturing and/or creating the telematics data (e.g., the sensors associated with the vehicle) to a platform independent format.

An operation 408 controls access to the telematics data stored in the privacy vault by the at least one service provider. In one implementation, the operation 406 controls the access to the telematics data according to the user-defined access permission set for the at least one service provider. Prior to providing access to the telematics data, a service offered by the service provider may be modeled using the telematics data stored in the privacy vault to provide insight for the particular user into a scope and nature of a potential offer for the service. For example, a behavior-based pricing service may be modeled prior to providing the service provider access to the telematics data, with the behavior-based pricing service modeled based on the telematics data stored in the privacy vault. Further, a first behavior-based pricing service of a first service provider may be compared to a second behavior-based pricing service of a second service provider. Based on the comparison, the particular user can decide which of the first and second service providers to provide access to the telematics data or to continue shopping for other service providers.

As described herein, the service provider cannot access the telematics data until permission is granted by the particular user. However, the particular user may not understand when sufficient data is accumulated in the privacy vault for use in providing the telematics-based service offered by the service provider. Accordingly, one or more parameters for the telematics-based service, such as data type, quantity of data, data time period, and/or the like may be provided for determining whether the telematics data meets the one or more parameters for a telematics-based service offered by the at least one service provider.

Further, in some cases, the service provider may need a reasonable certainty that the telematics data corresponds to the particular user as opposed to another user. For example, data may be generated in connection with another user masquerading as the particular user to qualify for certain benefits of the provider service, data may be ambiguously generated such that it is difficult to distinguish whether the data corresponds to the particular user or another user, and/or the like. As such, the telematics data may be confirmed to correspond to the particular user in connection with providing the behavior-based pricing service. Confirming that the telematics data corresponds to the particular user may include, without limitation: analyzing the telematics data based on authenticated data for the particular user (e.g., identifying behavioral patterns in the telematics data, cross-referencing the telematics data with other data for the particular user, etc.); obtaining an authentication certificate for the telematics data in connection with obtaining access to the telematics data stored in the privacy vault; and/or the like. In one implementation, the authentication certificate may be generated in connection with capturing the telematics data using one or more personal identifiers of the particular user (e.g., biometrics, pins, vehicle identifiers, etc.).

In some examples, controlling access to the telematics data stored in the privacy vault includes: prompting the particular user for permission to share the telematics data with the at least one service provider; automatically applying a prior permission by the particular user to share the telematics data; preventing unauthorized access to the telematics data by the at least one service provider; and/or the like.

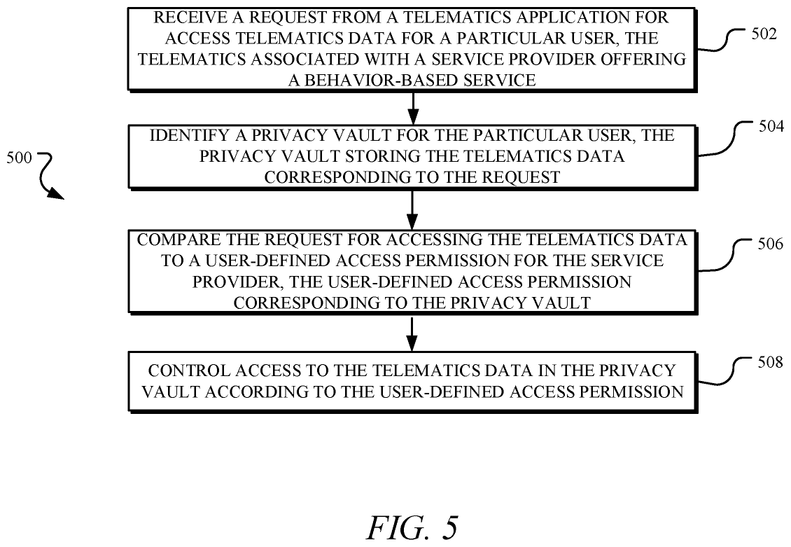

Turning to FIG. 5, example operations 500 for vehicle telematics control, including providing user-controlled access to telematics data, are illustrated. It will be appreciated, however, that the operations 500 may be applied in contexts involving other types of personal data, applications, and services. In one implementation, an operation 502 receives a request from a telematics application for accessing telematics data for a particular user. The telematics application may be executed by a service provider server associated with a service provider offering a behavior-based pricing service. The behavior-based pricing service may include generating an automobile insurance quote based on driving behavior for the particular user where the driving behavior is determined based on the telematics data for the particular user. As other examples, the telematics-based service may include characterizing a driving behavior of the particular user; determining whether a driving behavior of the particular user meets behavior thresholds to qualify for particular service offerings by the service provider; vehicle diagnostics and maintenance; and/or the like.

An operation 504 identifies a privacy vault in a privacy data store for the particular user. The privacy vault stores the telematics data corresponding to the request from the telematics application. An operation 506 compares the request for accessing the telematics data to a user-defined access permission for the service provider. The user-defined access permission corresponds to the privacy vault. An operation 508 controls access to the telematics data in the privacy vault in response to the request. The operation 508 controls the access according to the user-defined access permission. In some examples, controlling access to the telematics data stored in the privacy vault includes, without limitation: prompting the particular user for permission to share the telematics data with the at least one service provider; automatically applying a prior permission by the particular user to share the telematics data; preventing unauthorized access to the telematics data by the at least one service provider; and/or the like. In one example, the request includes a provider policy associated with the service provider. The operation 508 compares the provider policy to the user-defined access permission for the service provider in controlling access to the telematics data based on the user-defined access permission. As described herein, the user-defined access permission may include a data type, an access type, an access duration, an access value; and/or the like.

In some cases, certain actions may be taken prior to providing the telematics data to the service provider or otherwise responding to the request. For example, the telematics data may be confirmed to correspond to the particular user in connection with providing the behavior-based pricing service. The telematics data may be confirmed to correspond to the particular user based: an analysis of the telematics data based on authenticated data for the particular user; an authentication certificate for the telematics data obtained in connection with obtaining access to the telematics data stored in the privacy vault; and/or the like as described herein. Prior to providing access to the telematics data, the behavior-based pricing service may be modeled using the telematics data stored in the privacy vault to provide insight for the particular user into a scope and nature of the behavior-based pricing service. Further, the behavior-based pricing service of the service provider may be compared to a second behavior-based pricing service of a second service provider. Based on the comparison, the particular user can decide which of the service providers to provide access to the telematics data or to continue shopping for other service providers. Alternatively or additionally, the request may include one or more parameters for the telematics-based service, where the telematics data is accessed upon a confirmation that the telematics data meets the one or more parameters. The parameters may include, without limitation, data type, quantity of data, data time period, and/or the like may be provided for determining whether the telematics data meets the one or more parameters for a telematics-based service offered by the at least one service provider.

As described herein, the behavior-based pricing service may include generating a behavior profile for the particular user using the telematics data; and providing the behavior-based service based on the behavior profile for the particular user. For example, the behavior-based pricing service may involve generating an automobile insurance quote based on driving behavior for the particular user where the driving behavior is determined based on the telematics data for the particular user. As other examples, the telematics-based service may include characterizing a driving behavior of the particular user; determining whether a driving behavior of the particular user meets behavior thresholds (e.g., safe driving thresholds) to qualify for particular service offerings by the service provider (e.g., a safe driving discount); vehicle diagnostics and maintenance; and/or the like.

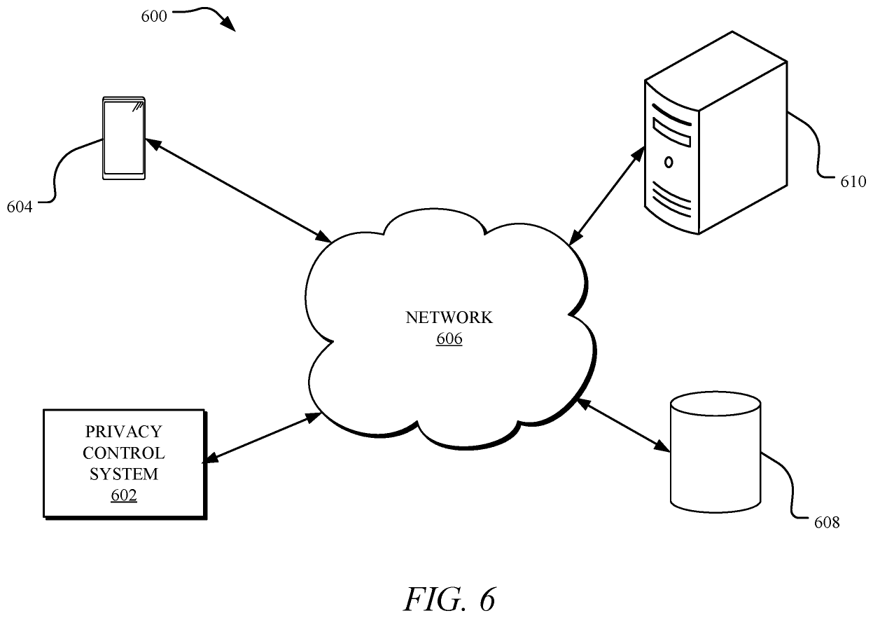

Turning to FIG. 6, an example network environment 600 of an end-to-end privacy ecosystem for implementing a privacy control system 602 is illustrated. As depicted in FIG. 6, a network 606 is used by one or more computing or data storage devices for implementing the privacy control system 602 for providing a user-controlled access to personal data for a particular user. The privacy control system 602 may incorporate one or more features of the privacy control system 110 and/or the privacy control system 202. The privacy control system 602 may generate a user interface for interaction with various aspects of the privacy control system 602 by one or more computing devices 604.

In one implementation, the computing devices 604, one or more databases 608, and/or other network components or computing devices described herein are communicatively connected to the network 606. Examples of the computing devices 604 include a terminal, personal computer, a smartphone, a tablet, a mobile computer, a workstation, and/or the like. The computing devices 604 may include the user device 204 and include or otherwise be associated with the provider systems 206 and/or the other systems 208. For example, the computing devices 604 may include one or more provider servers executing service-based applications associated with service providers. The databases 608 may include the personal data store 210, the personal value store 212, the service data store 214 and/or the like. The databases 608 may store personal data, service data, value data, and software and modules related to user-controlled data access.

As shown in FIG. 6, a server 610 hosts the network environment 600. In one implementation, the server 610 also hosts a website or an application that users may visit to access the privacy control system 602 and personal data. The server 610 may be one single server, a plurality of servers with each such server being a physical server or a virtual machine, or a collection of both physical servers and virtual machines. In another implementation, a cloud hosts one or more components of the network environment 600. The privacy control system 602, the computing devices 604, the server 610, and other resources connected to the network 606 may access one or more additional servers for access to one or more websites, applications, web services interfaces, and/or the like that are used for user-controlled personal data access (e.g., service-based applications associated with service providers). In one implementation, the server 610 also hosts a search engine that used for accessing and modifying personal data control parameters.

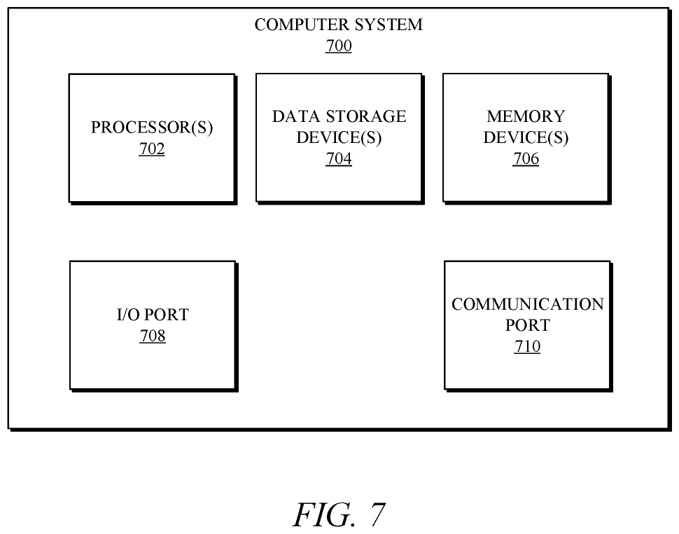

Referring to FIG. 7, a detailed description of an example computing system 700 having one or more computing units that may implement various systems and methods discussed herein is provided. The computing system 700 may be applicable to the telematics device 104, the mobile device 106, the provider system 108, the privacy control system 110, the privacy control system 202 (including each of the sub-components and systems), the user device 204, the provider systems 206, the other systems 208, and other computing or network devices. It will be appreciated that specific implementations of these devices may be of differing possible specific computing architectures not all of which are specifically discussed herein but will be understood by those of ordinary skill in the art.

The computer system 700 may be a computing system is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 708, and/or one or more ports 708-710. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computer system 700 may be a conventional computer, a distributed computer, or any other type of computer, such as one or more external computers made available via a cloud computing architecture. The presently described technology is optionally implemented in software stored on the data stored device(s) 704, stored on the memory device(s) 706, and/or communicated via one or more of the ports 708-710, thereby transforming the computer system 700 in FIG. 7 to a special purpose machine for implementing the operations described herein. Examples of the computer system 700 include personal computers, terminals, workstations, mobile phones, tablets, laptops, personal computers, multimedia consoles, gaming consoles, set top boxes, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708 and a communication port 710, for communicating with other computing, network, or vehicle devices. It will be appreciated that the ports 708-710 may be combined or separate and that more or fewer ports may be included in the computer system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 700, such as, physical movement of some object (e.g., a mechanical actuator), heating or cooling of a substance, adding a chemical substance, and/or the like.

In one implementation, a communication port 710 is connected to a network by way of which the computer system 700 may receive network data useful in executing the methods and systems set out herein as well as transmitting information and network configuration changes determined thereby. Stated differently, the communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 710 may communicate with an antenna or other link for electromagnetic signal transmission and/or reception.

In an example implementation, personal data access control software and other modules and services may be embodied by instructions stored on the data storage devices 704 and/or the memory devices 706 and executed by the processor 702.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for vehicle telematics control for a particular user, the method comprising:
obtaining telematics data for the particular user, the telematics data captured using at least one sensor associated with a vehicle in connection with an operation of the vehicle by the particular user;
identifying a privacy vault of the particular user, the privacy vault having a user-defined access permission set for at least one service provider;
storing the telematics data in the privacy vault; and
controlling access to the telematics data stored in the privacy vault by the at least one service provider, the access to the telematics data controlled according to the user-defined access permission set for the at least one service provider.

2. The method of claim 1, wherein the user-defined access permission is set for the at least one service provider based on one or more user preferences for the particular user and one or more provider conditions for the at least one service provider.

3. The method of claim 2, wherein the one or more provider conditions are defined by a standardized access tier.

4. The method of claim 2, wherein the one or more provider conditions are generated based on one or more provider policies of the at least one service provider.

5. The method of claim 1, wherein the user-defined access permission includes one or more of a data type, an access type, an access duration, and an access value.

6. The method of claim 5, wherein the access type includes a service-related use in providing a telematics-based service to the particular user.

7. The method of claim 6, wherein the telematics-based service includes a behavior-based service.

8. The method of claim 7, further comprising:
modeling the behavior-based service prior to providing the at least one service provider access to the telematics data, the behavior-based service modeled based on the telematics data stored in the privacy vault.

9. The method of claim 8, wherein modeling the behavior-based service includes comparing a first behavior-based service of a first service provider of the at least one service provider to a second behavior-based service of a second service provider of the at least one service provider.

10. The method of claim 5, wherein the access value includes at least one of compensation or a discount.

11. The method of claim 1, wherein controlling access to the telematics data stored in the privacy vault includes at least one of: prompting the particular user for permission to share the telematics data with the at least one service provider; automatically applying a prior permission by the particular user to share the telematics data; or preventing unauthorized access to the telematics data by the at least one service provider.

12. The method of claim 1, further comprising:
determining whether the telematics data meets one or more parameters for a telematics-based service offered by the at least one service provider.

13. The method of claim 1, further comprising:
providing an authentication certificate with the telematics data to the at least service provider in connection with the access to the telematics data, the authentication certificate certifying that the telematics data corresponds to the particular user.

14. One or more tangible non-transitory computer-readable storage media storing computer-executable instructions for performing a computer process on a computing system, the computer process comprising:
requesting telematics data for a particular user in connection with a telematics-based service offered by a service provider, the telematics data captured using at least one sensor associated with a vehicle in connection with an operation of the vehicle by the particular user, the telematics data stored in a privacy vault the particular user, the privacy vault having a user-defined access permission set for the service provider; and
obtaining access to the telematics data stored in the privacy vault by a service provider server, the access to the telematics data controlled according to the user-defined access permission set for the service provider.

15. The one or more tangible non-transitory computer-readable storage media of claim 14, wherein the telematics-based service includes a behavior-based service.

16. The one or more tangible non-transitory computer-readable storage media of claim 15, the computer process further comprising:
confirming that the telematics data corresponds to the particular user in connection with providing the behavior-based service.

17. The one or more tangible non-transitory computer-readable storage media of claim 16, wherein confirming that the telematics data corresponds to the particular user includes at least one of: analyzing the telematics data based on authenticated data for the particular user; or obtaining an authentication certificate for the telematics data in connection with obtaining access to the telematics data stored in the privacy vault.

18. A system for vehicle telematics control for a particular user, the system comprising:
at least one sensor associated with a vehicle, the at least one sensor capturing telematics data for the particular user in connection with an operation of the vehicle by the particular user; and
at least one computing device sending the telematics data to a privacy control system, the privacy control system storing the telematics data in a privacy vault of the particular user, the privacy vault having a user-defined access permission set for a service provider.

19. The system of claim 18, wherein the at least one computing device is a mobile device associated with the particular user.

20. The system of claim 19, wherein the at least one sensor is integrated with the mobile device or in communication with the mobile device.

21. A method for vehicle telematics control for a particular user, the method comprising:
receiving a request from a user device to sign into a telematics application for a telematics-based service, the telematics application executed by a service provider server associated with a service provider;
determining one or more provider conditions for the telematics application;
identifying one or more user preferences of the particular user for controlling access to one or more data types corresponding to the telematics application;
generating a comparison of the one or more provider conditions for the telematics application with the one or more user access preferences;
identifying a privacy vault for the particular user for storing data associated with the telematics application; and
generating a user-defined access permission for the service provider based on the comparison, the user-defined access permission corresponding to the privacy vault.

22. The method of claim 21, wherein the data associated with the telematics application includes telematics data, the method further comprising:
obtaining telematics data requested by the telematics application for the particular user, the telematics data captured using at least one sensor associated with a vehicle in connection with an operation of the vehicle by the particular user.

23. The method of claim 22, further comprising:
controlling access to the telematics data by the telematics application according to the user-defined access permission for the service provider.

24. The method of claim 21, wherein determining the one or more provider conditions for the telematics application includes:
parsing a provider policy for the telematics application;
extracting one or more policy requirements from the provider policy based on pre-defined criteria; and
generating the one or more provider conditions based on the one or more policy requirements.

25. The method of claim 21, wherein determining the one or more provider conditions for the telematics application includes identifying a standardized tier corresponding to a provider policy for the telematics application, the standardized tier defining the one or more provider conditions.

26. The method of claim 21, wherein generating the user-defined access permission includes:
identifying any differences between the one or more provider conditions and the one or more user preferences based on the comparison;
generating a notification explaining the differences between the one or more provider conditions and the one or more user preferences, the notification sent to the user device; and
receiving a resolution of the differences between the one or more provider conditions and the one or more user preferences, the user-defined access permission generated based on the resolution.

27. The method of claim 21, wherein identifying the privacy vault for the particular user includes at least one of defining or selecting the privacy vault in response to the request from the user device.

28. The method of claim 21, wherein the user-defined access permission includes one or more of a data type, an access type, an access duration, and an access value.

29. The method of claim 28, wherein the access value includes at least one of compensation or a discount.

30. The method of claim 28, wherein the access type includes one or more of a service-related use, targeted advertising, third-party sharing, selling, storing, and access-only.

31. The method of claim 21, wherein the telematics-based service includes a behavior-based service.

32. One or more tangible non-transitory computer-readable storage media storing computer-executable instructions for performing a computer process on a computing system, the computer process comprising:
prompting a user to selectively sign into a telematics application for a telematics-based service, the telematics application executed by a service provider server associated with a service provider;
providing a provider policy for the telematics application; and
receiving an indication of a user-defined access permission for the service provider, the user-defined access permission corresponding to a privacy vault for the particular user, the user-defined access permission defined based on a comparison of one or more provider conditions for the provider policy with one or more user access preferences for the privacy vault.

33. The one or more tangible non-transitory computer-readable storage media of claim 32, the computer process further comprising:
requesting telematics data for the particular user, the telematics data captured using at least one sensor associated with a vehicle in connection with an operation of the vehicle by the particular user.

34. The one or more tangible non-transitory computer-readable storage media of claim 33, the computer process further comprising:
accessing to the telematics data according to the user-defined access permission for the service provider.

35. The one or more tangible non-transitory computer-readable storage media of claim 32, wherein the user-defined access permission includes one or more of a data type, an access type, an access duration, and an access value.

36. The one or more tangible non-transitory computer-readable storage media of claim 32, wherein the access value includes at least one of compensation or a discount, the computer process further comprising at least of:
providing the compensation to a personal value store associated with the particular user; or
providing the discount in connection with providing the telematics-based service to the particular user.

37. A system for vehicle telematics control for a particular user, the system comprising:
at least one computing device sending a request to sign into a telematics application for a telematics-based service, the telematics application executed by a service provider server associated with a service provider; and
a display of the at least one computing device presenting an indication of a user-defined access permission for the service provider, the user-defined access permission corresponding to a privacy vault for the particular user, the user-defined access permission defined based on a comparison of one or more provider conditions for the telematics application with one or more user access preferences for the privacy vault.

38. The system of claim 37, wherein the at least one computing device obtains telematics data for the particular user in connection with an operation of a vehicle by the particular user, the telematics data captured using at least one sensor associated with the vehicle.

39. The system of claim 37, wherein the at least one computing device is a mobile device associated with the particular user.

40. The system of claim 37, wherein the at least one computing device defines the one or more user access permissions for the privacy vault through one or more prompts to the user presented using the display.

41. A method for vehicle telematics control for a particular user, the method comprising:
receiving a request from a telematics application for accessing telematics data for a particular user, the telematics application executed by a service provider server associated with a service provider offering a behavior-based service;
identifying a privacy vault for the particular user, the privacy vault storing the telematics data corresponding to the request from the telematics application;
comparing the request for accessing the telematics data to a user-defined access permission for the service provider, the user-defined access permission corresponding to the privacy vault; and
controlling access to the telematics data in the privacy vault in response to the request, the access controlled according to the user-defined access permission.

42. The method of claim 41, wherein the user-defined access permission includes one or more of a data type, an access type, an access duration, and an access value.

43. The method of claim 42, wherein the access value includes at least one of compensation or a discount.

44. The method of claim 42, wherein the access type includes one or more of a service-related use, targeted advertising, third-party sharing, selling, storing, and access-only.

45. The method of claim 41, wherein the behavior-based service includes generating an automobile insurance quote based on driving behavior for the particular user, the driving behavior determined based on the telematics data for the particular user.

46. The method of claim 41, wherein the telematics data is confirmed to correspond to the particular user in connection with providing the behavior-based service.

47. The method claim 46, wherein the telematics data is confirmed to correspond to the particular user based on at least one of: an analysis of the telematics data based on authenticated data for the particular user; or an authentication certificate for the telematics data obtained in connection with obtaining access to the telematics data stored in the privacy vault.

48. The method of claim 41, further comprising:
modeling the behavior-based service prior to providing the service provider access to the telematics data, the behavior-based service modeled based on the telematics data stored in the privacy vault.

49. The method of claim 48, wherein modeling the behavior-based service includes comparing the behavior-based service of the service provider to a second behavior-based service of a second service provider, the second behavior-based service generated based on the telematics data stored in the privacy vault.

50. The method of claim 41, wherein controlling access to the telematics data stored in the privacy vault includes at least one of: prompting the particular user for permission to share the telematics data with the service provider; automatically applying a prior permission by the particular user to share the telematics data; or preventing unauthorized access to the telematics data by the service provider.

51. One or more tangible non-transitory computer-readable storage media storing computer-executable instructions for performing a computer process on a computing system, the computer process comprising:
generating a request for accessing telematics data for a particular user, the request associated with a service provider offering a telematics-based service;
sending the request to a privacy control system; and
accessing the telematics data using the privacy control system based on a user-defined access permission controlling access to a privacy vault associated with the particular user, the privacy vault storing the telematics data.

52. The one or more tangible non-transitory computer-readable storage media of claim 51, wherein the request includes a provider policy associated with the service provider and accessing the telematics data based on a user-defined access permission includes comparing the provider policy to the user-defined access permission for the service provider.

53. The one or more tangible non-transitory computer-readable storage media of claim 51, wherein the request includes one or more parameters for the telematics-based service, the telematics data accessed upon a confirmation that the telematics data meets the one or more parameters.

54. The one or more tangible non-transitory computer-readable storage media of claim 51, wherein the telematics-based service is a behavior-based service.

55. The one or more tangible non-transitory computer-readable storage media of claim 54, further comprising:
generating a behavior profile for the particular user using the telematics data; and
providing the behavior-based service based on the behavior profile for the particular user.

56. The one or more tangible non-transitory computer-readable storage media of claim 55, wherein the behavior-based service includes generating an automobile insurance quote based on the behavior profile for the particular user, the behavior profile including driving behavior.

57. The one or more tangible non-transitory computer-readable storage media of claim 51, further comprising at least of:
providing the compensation to a personal value store associated with the particular user according to the user-defined access permission; or
providing the discount in connection with providing the telematics-based service to the particular user according to the user-defined access permission.

58. A system for vehicle telematics control for a particular user, the system comprising:
at least one computing device receiving a notification from a privacy control system, the notification specifying a request by a telematics application to access telematics data associated with a particular user, the telematics application executed by a service provider server associated with a service provider; and
a display of the at least one computing device presenting an indication of a user-defined access permission for the service provider, the user-defined access permission corresponding to a privacy vault for the particular user, the privacy vault storing the telematics data, access to the telematics data by the telematics application controlled based on the user-defined access permission.

59. The system of claim 58, wherein presentation of the indication of the user-defined access permission includes a prompt for the particular user to authorize access of the telematics data by the telematics device according to the user-defined access permission.

60. The system of claim 58, wherein controlling access to the telematics data stored in the privacy vault includes at least one of: prompting the particular user for permission to share the telematics data with the service provider; automatically applying a prior permission by the particular user to share the telematics data; or preventing unauthorized access to the telematics data by the service provider.
